(19) United States
(12) Patent Application Publication
(10) Pub. No.: US 2026/0211770 A1
(43) Pub. Date: Jul. 23, 2026

(54) NETWORK ANOMALY DETECTION AND AUTOMATIC PROCESSING METHOD AND SYSTEM, STORAGE MEDIUM AND DEVICE

(71) Applicant: Linkplay Technology Inc., Newark, CA (US)

(72) Inventors: Tao JIANG, Newark, CA (US); Lifeng ZHAO, Newark, CA (US)

(73) Assignee: Linkplay Technology Inc., Newark, CA (US)

(21) Appl. No.: 19/455,790

(22) Filed: Jan. 21, 2026

(30) Foreign Application Priority Data
Jan. 22, 2025 (CN) 202510101205.7

(51) Int. Cl. G06F 11/07

(52) U.S. Cl. CPC G06F 11/0793; G06F 11/0709; G06F 11/0766

(57) ABSTRACT

A network anomaly detection and automatic processing method includes: collecting multi-dimensional data related to network performance, pre-processing collected data, and performing construction of feature engineering on pre-processed data; constructing a multi-dimensional anomaly detection model, performing time series anomaly detection, multi-dimensional feature cluster analysis and rule engine detection through the multi-dimensional anomaly detection model; performing classification and automatic processing on anomalies output through detection with the multi-dimensional anomaly detection model; performing event tracking on network performance indicators and anomaly events, monitoring states of various layers of network in real time and tracking and recording the anomaly events, meanwhile, performing prediction analysis on network performance data, mining data values through trend and correlation analysis, and generating optimization recommendations based on prediction analysis results. Through the above method, a network anomaly detection and automatic processing system is achieved, and network quality and experience are improved.

### CROSS REFERENCE TO THE RELATED APPLICATIONS

This application is based upon and claims priority to Chinese Patent Application No. 202510101205.7, filed on Jan. 22, 2025, the entire contents of which are incorporated herein by reference.

### TECHNICAL FIELD

The present disclosure relates to the technical field of network detection optimization, and particularly relates to a network anomaly detection and automatic processing method and system, a storage medium and a device.

### BACKGROUND

With the development of 6G network technologies, network architectures are increasingly complex, and network management in particular under same SSID scenarios faces many challenges.

The prior art mainly has the following problems: first, conventional network monitoring solutions are mainly designed for 4G/5G network, characteristics and demands of 6G network are not sufficiently considered, there are problems of not-timely network switching, disconnection caused by signal interference, an imperfect automatic reconnection mechanism, and so on; second, an anomaly detection method is too simple to efficiently identify complex anomaly patterns based on only a single indicator threshold judgment; again, network anomaly processing is dominated by manual intervention, the response speed is slow, and misoperation is prone to occurring; finally, the lack of systematic data collection and analysis mechanisms makes it difficult to support continuous optimization of network performance.

Thus, it can be seen that existing network monitoring solutions lack an anomaly detection capability for 6G specific scenarios and mostly adopt a passive response patten, failing to achieve early warning and automatic processing of network anomalies and affecting user experience and network performance. These problems severely impact the service quality and user experience of the 6G network.

### SUMMARY

The objectives of the present disclosure are to provide a network anomaly detection and automatic processing method and system, a storage medium and a device for solving the drawbacks existing in the prior art. By monitoring network performance indicators in real time, a multi-dimensional anomaly detection model is built, and anomaly early warning is achieved in combination with a machine learning algorithm. Meanwhile, an intelligent automatic processing flow is designed, and operations such as network switching and signal optimization according to anomaly types can be automatically performed, and anomaly data is collected through event tracking for continuous optimization.

In one aspect, provided is a network anomaly detection and automatic processing method, including the following steps:
S1: collecting multi-dimensional data related to network performance, performing pre-processing including noise removal, outlier processing and data standardization on collected data, and performing construction of feature engineering on pre-processed data;
S2: constructing a multi-dimensional anomaly detection model based on deep learning and machine learning algorithms, and performing time series anomaly detection based on a long short-term memory LSTM, multi-dimensional feature cluster analysis based on density-based spatial clustering of applications with noise DBSCAN and rule engine detection based on expert rules through the multi-dimensional anomaly detection model;
S3: performing classification on anomalies output through detection with the multi-dimensional anomaly detection model based on a hierarchical classification strategy, and executing corresponding automatic processing strategies according to anomaly types;
S4: performing multi-level event tracking on network performance indicators and anomaly events, monitoring states of various layers of network in real time and tracking and recording the anomaly events, meanwhile, performing trend prediction analysis on network performance data through an exponential smoothing method, performing correlation analysis based on a Pearson correlation coefficient to mine data values, and generating optimization recommendations on the basis of prediction analysis results in combination with a decision tree algorithm.

Further, in step S1, the multi-dimensional data includes network basic indicators and network high-level indicators, where collecting the network basic indicators includes:

collecting signal strength RSSI of the network continuously according to a configurable time interval, and evaluating a degree of weakness of wireless signals in transmission;
acquiring round-trip time RTT by recording a time difference between sending a specific detection request packet to a target server and receiving a response packet returned by the target server in an active detection manner;
recording, at a sending end, a total number of data packets sent within a specific time period based on a sliding window mechanism, and acquiring a data packet loss rate;
acquiring traffic statistical information of network interfaces by a management interface provided by a network device to acquire a bandwidth availability;
calculating a channel quality indicator CQI value in real time according to received signal properties;
collecting the network high-level indicators includes:
performing normalization and weighted summation on basic indicators based on an adaptive weight mechanism to obtain a network stability index NSI, where the network stability index NSI is used for comprehensively evaluating stability of the network, where a weight coefficient is adjusted according to actual situations;
calculating a ratio of a number of anomaly samples to a total number of samples through a size-configurable sliding window method to obtain an anomaly rate for evaluating anomaly situations of the network.

Further, in step S1, the performing pre-processing including noise removal, outlier processing and data standardization on collected data further includes:
performing preliminary anomaly detection on data using a statistical method, including removing obvious noise and outliers in the data using a Z-score method and a box plot method, and filling in missing values through an interpolation method and a nearest neighbor interpolation method;
employing a Z-score standardization method to convert data features of different ranges and magnitudes to a same scale, and performing normalization and standardization on the data features to avoid imbalance of contribution of different features to the anomaly detection model due to differences in magnitude.

Further, in step S1, the performing construction of feature engineering on pre-processed data further includes:
selecting relevant features from collected raw data based on random forest and mutual information evaluation methods, and screening features most valuable for anomaly detection through a feature importance evaluation method;
extracting time features including hour, minute, second and period features of time stamps in time series data, and performing feature combination on the multi-dimensional data through an interactive feature generation method to capture non-linear relationships between different dimensions.

Further, in step S2, the multi-dimensional anomaly detection model includes a time series anomaly detection model, a multi-dimensional feature cluster analysis model and a rule engine detection model, where constructing the time series anomaly detection model includes:
collating the time series data into a three-dimensional tensor format including a number of samples, a time step and a number of features based on time series data features, and splitting the time series data into a training set, a validation set and a test set according to a set proportion;
constructing a deep neural network model including multiple layers of long short-term memory LSTM structures, and using the training set and a backpropagation algorithm for model training;
inputting the validation set to adjust hyperparameters, including a learning rate, a number of LSTM units and a Dropout proportion, based on grid search and cross validation methods;
performing predictive tests by inputting the test set, and using indicators including a recall rate, a precision rate and an F1 score for evaluating performance of the time series anomaly detection model.

Preferably, constructing the multi-dimensional feature cluster analysis model includes:
creating a sample data set including multi-dimensional features by merging data in multiple dimensions into one feature matrix based on feature correlation analysis;
constructing the multi-dimensional feature cluster analysis model based on density-based spatial clustering of applications with noise DBSCAN, determining an optimal neighborhood radius and a minimum sample number parameter through the grid search, evaluating cluster quality using a profile coefficient and a DTW distance, and meanwhile, evaluating plausibility of outlier points in combination with expert experience.

More preferably, constructing the rule engine detection model includes:
encoding various rules into executable logic based on the expert experience and historical anomaly cases, and building a rule base including rule priorities, trigger conditions and execution actions;
constructing the rule engine detection model through rule conflict detection and a priority ranking mechanism, and performing online evaluation and optimization of the rule engine detection model according to a number of anomalies triggered in actual applications, processing effects and resource consumption situations.

Further, in step S2, the performing time series anomaly detection based on a long short-term memory LSTM, multi-dimensional feature cluster analysis based on density-based spatial clustering of applications with noise DBSCAN and rule engine detection based on expert rules through the multi-dimensional anomaly detection model further includes:
determining a threshold of a standard deviation using a 3σ criterion and a quantile-based method based on historical data distribution features, using the standard deviation as a significant indicator for measuring a deviation between a predicted value and an actual value, and predicting a normal network performance indicator range through the time series anomaly detection model;
collating the multi-dimensional data into a feature matrix according to a time series, dividing the data into normal clusters and anomaly points based on density threshold determination through the multi-dimensional feature cluster model, where a density threshold is dynamically adjusted according historical data;
executing the rule engine detection based on a priority order, accordingly matching input network performance data with rules in the rule base, and returning corresponding anomaly states and severity degrees when rule conditions are satisfied.

Further, in step S2, the performing classification on anomalies output through detection with the multi-dimensional anomaly detection model based on a hierarchical classification strategy further includes:
determining classes to which anomaly items belong based on the hierarchical classification strategy, where the classes of the anomalies include:
anomalies in a network congestion class, eigenvectors of the anomalies being manifested as high network delay, a high packet loss rate and a low bandwidth availability;
anomalies in a signal interference class, eigenvectors of the anomalies being manifested as low signal strength, a low channel quality indicator and a high bit error rate; and
anomalies in a hardware fault class, eigenvectors of the anomalies being manifested as bursty disconnection, abnormal restart and configuration errors;
meanwhile, setting a severity degree level for each class of anomalies, and performing priority ranking based on a duration, an impact range and a service impact degree of the anomalies.

Further, in step S3, the executing corresponding automatic processing strategies according to anomaly types further includes:
based on a strategy matching algorithm of multi-dimensional feature similarity, calculating a similarity score of a current anomaly to a historical case, and generating a candidate processing strategy set;
according to strategy applicable conditions, historical execution effects and resource consumption situations, selecting optimal strategies, including network switching, parameter optimization and fault self-recovery, from a processing strategy library, and setting a rollback point of strategy execution;
quantifying and evaluating execution effects of processing strategies by calculating a relative improvement degree of key performance indicators, and triggering a rollback mechanism if the improvement degree does not reach an expected level;
employing a strategy optimization algorithm based on deep reinforcement learning and updating weights of the processing strategies by calculating reward values of strategy execution to achieve online learning and optimization of the processing strategies.

Further, in step S4, the performing multi-level event tracking on network performance indicators and anomaly events further includes:
setting a sampling frequency of event tracking based on a hierarchical sampling strategy, employing high-frequency sampling for core indicators, and employing low-frequency sampling for secondary indicators;
collecting and storing data at various layers, including a physical layer, a protocol layer and an application layer, of the network in real time, where
data at the physical layer includes: network interface states, physical connection states, an operating rate and a duplex mode;
data at the protocol layer includes: TCP/IP performance indicators, protocol stack states and network protocol interaction data;
data at the application layer includes: service response time, a service success rate and user experience data;
recording anomaly events and their complete lifecycles in real time, where the anomaly events include network switching events, parameter adjustment events and fault processing events, and recorded content includes event occurrence time, type determination, processing processes, execution results and effect evaluation.

Further, in step S4, the generating optimization recommendations further includes:
analyzing and predicting a network performance trend based on an exponential smoothing method of adaptive parameters, performing correlation analysis in combination with the Pearson correlation coefficient and mutual information indicators, and evaluating an association relationship between the network performance indicators;
employing a decision tree algorithm based on information gains, taking significantly correlated indicators as decision nodes, and constructing a network optimization decision model;
performing composite scoring and priority ranking on the optimization recommendations according to the following factors:
an emergency degree based on the severity degrees and the impact ranges of the anomalies;
resource consumption based on required resources and technical conditions;
an impact range based on historical optimization effects and service impact evaluation;
meanwhile, building an execution feedback mechanism of the optimization recommendations, and continuously evaluating and improving the optimization effects.

In another aspect, provided is a network anomaly detection and automatic processing system, including:
an indicator collection module for collecting multi-dimensional data related to network performance, performing pre-processing including noise removal, outlier processing and data standardization on collected data, and performing construction of feature engineering on pre-processed data;
an anomaly detection module for constructing a multi-dimensional anomaly detection model based on deep learning and machine learning algorithms, and performing time series anomaly detection based on a long short-term memory LSTM, multi-dimensional feature cluster analysis based on density-based spatial clustering of applications with noise DBSCAN and rule engine detection based on expert rules through the multi-dimensional anomaly detection model;
a strategy execution model for performing classification on anomalies output through detection with the multi-dimensional anomaly detection model based on a hierarchical classification strategy, and executing corresponding automatic processing strategies according to anomaly types;
a data analysis module for performing multi-level event tracking on network performance indicators and anomaly events, monitoring states of various layers of a network in real time and tracking and recording the anomaly events, meanwhile, performing trend prediction analysis on network performance data through an exponential smoothing method, performing correlation analysis based on a Pearson correlation coefficient to mine data values, and generating optimization recommendations on the basis of prediction analysis results in combination with a decision tree algorithm.

Also, provided is an electronic device, including: one or more processors; a storage device for storing one or more programs, where the one or more programs, when executed by the one or more processors, cause the one or more processors to implement the network anomaly detection and automatic processing method according to any one of the above.

Compared with the prior art, the beneficial effects of the present disclosure are as follows:

According to the present disclosure, a multi-dimensional indicator collection and analysis system is adopted to achieve comprehensive perception of network states by monitoring core indicators such as signal strength, network delay, a data packet loss rate in real time and combining an innovative calculation method of a network stability index (NSI);
according to the present disclosure, at the level of anomaly detection, triple detection mechanisms of LSTM time series analysis, DBSCAN clustering and expert rule engines are merged, greatly improving accuracy and reliability of anomaly identification;
according to the present disclosure, in terms of automatic processing, an intelligent strategy generation system based on reinforcement learning is designed, processing measures such as network switching, parameter optimization or fault self-recovery according to anomaly types can be automatically performed, and manual intervention requirements are significantly reduced;
according to the present disclosure, a complete data event tracking and analysis system is built, and system performance is continuously optimized through exponential smoothing prediction and decision tree analysis. This closed-loop optimization mechanism enables the system to continuously evolve itself, adapting to dynamic changes of the network environment.

### BRIEF DESCRIPTION OF THE DRAWINGS

The accompanying drawings are used for providing a further understanding of the present disclosure, constitute a part of this specification, are used for explaining the present disclosure together with embodiments of the present disclosure, and are not to be construed as limiting the present disclosure. In the drawings:

FIG. 1 is a flowchart of a network anomaly detection and automatic processing method according to the present disclosure;

FIG. 2 is schematic diagram of a collection process of network performance indicators according to the present disclosure;

FIG. 3 is a structure block diagram of a multi-dimensional anomaly detection model according to the present disclosure;

FIG. 4 is a schematic diagram of an anomaly detection process according to the present disclosure;

FIG. 5 is a schematic diagram of an anomaly automatic processing process according to the present disclosure;

FIG. 6 is a schematic diagram of data event tracking design according to the present disclosure;

FIG. 7 is a schematic diagram of indicator data analysis and optimization recommendation generation according to the present disclosure;

FIG. 8 is a block diagram of integration and deployment structures of a network anomaly detection and automatic processing system according to the present disclosure;

FIG. 9 is a schematic diagram of an embodiment of an electronic device according to the present disclosure.

### DETAILED DESCRIPTION OF THE EMBODIMENTS

In order to make the objectives, technical solutions and advantages of the embodiments of the present application more clear, the technical solutions in the embodiments of the present application will be clearly and completely described below in conjunction with the accompanying drawings in the embodiments of the present application, and it is obvious that the described embodiments are some of the embodiments of the present application, rather than all of the embodiments. Based on the embodiments in the present application, all other embodiments obtained by those of ordinary skill in the art without making inventive labor belong to the scope of protection of the present application.

The embodiments of the present disclosure design an innovative calculation method of a network stability index (NSI), which constructs triple anomaly detection mechanisms by monitoring multi-dimensional indicators such as signal strength, network delay and a data packet loss rate in real time and combining LSTM time series analysis, DBSCAN clustering and expert rules engines, and the multi-level detection architecture has not been seen in existing technical solutions. Especially, in terms of anomaly processing, an intelligent strategy generation system based on reinforcement learning is introduced into the solution, which can adaptively perform processing measures such as network switching, parameter optimization or fault self-recovery according to different types of anomalies.

Detailed descriptions of the embodiments of the present disclosure will now be illustrated with reference to the accompanying drawings and the embodiments.

### First Embodiment

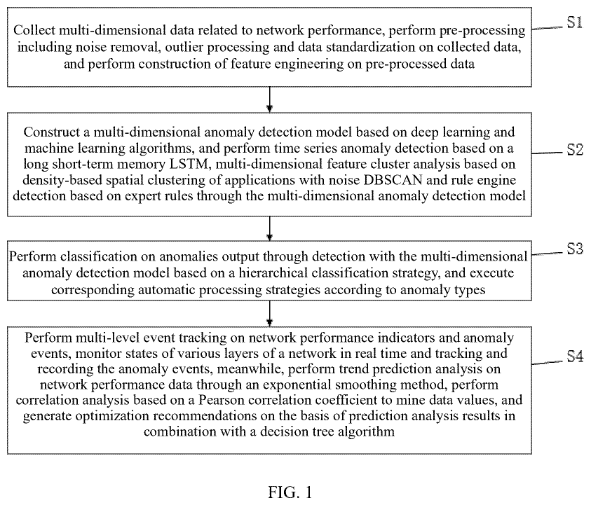

Referring to FIG. 1, the present embodiment provides a network anomaly detection and automatic processing method, and the technical solution includes the following steps:
S1: collecting multi-dimensional data related to network performance, performing pre-processing including noise removal, outlier processing and data standardization on collected data, and performing construction of feature engineering on pre-processed data;
S2: constructing a multi-dimensional anomaly detection model based on deep learning and machine learning algorithms, and performing time series anomaly detection based on a long short-term memory LSTM, multi-dimensional feature cluster analysis based on density-based spatial clustering of applications with noise DBSCAN and rule engine detection based on expert rules through the multi-dimensional anomaly detection model;
S3: performing classification on anomalies output through detection with the multi-dimensional anomaly detection model based on a hierarchical classification strategy, and executing corresponding automatic processing strategies according to anomaly types;
S4: performing multi-level event tracking on network performance indicators and anomaly events, monitoring states of various layers of network in real time and tracking and recording the anomaly events, meanwhile, performing trend prediction analysis on network performance data through an exponential smoothing method, performing correlation analysis based on a Pearson correlation coefficient to mine data values, and generating optimization recommendations on the basis of prediction analysis results in combination with a decision tree algorithm.

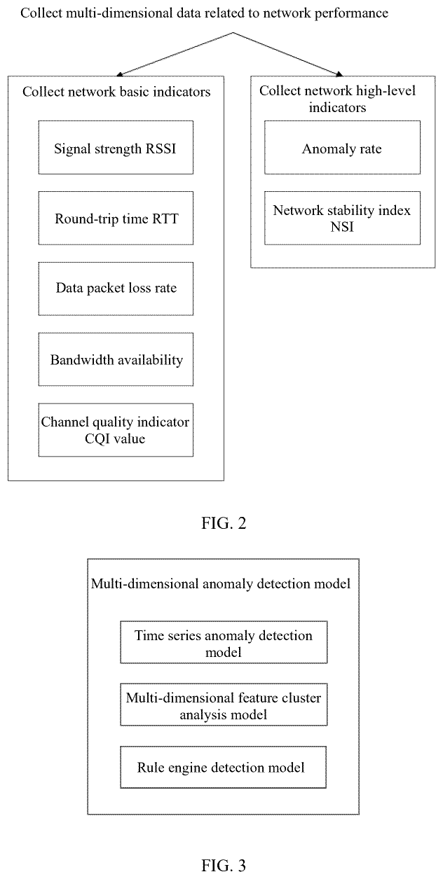

In step S1, the multi-dimensional data includes network basic indicators and network high-level indicators, as shown in FIG. 2, where in the present embodiment, collecting the network basic indicators includes:
collecting signal strength RSSI of the network once every 100 ms according to a set time interval, and evaluating a degree of weakness of wireless signals in transmission;
collecting the round-trip time RTT once every 500 ms in an active detection manner, and acquiring the round-trip time RTT by recording a time difference between sending a specific detection request packet to a target server and receiving a response packet returned by the target server;
recording, at a sending end, a total number of sent data packets once every 1 s of calculation based on a sliding window mechanism, and acquiring a data packet loss rate PacketLoss;
collecting the bandwidth availability once every 1 s, and acquiring traffic statistical information of network interfaces by a management interface provided by a network device to acquire a bandwidth availability Bandwidth;
collecting a channel quality indicator CQI once every 200 ms, calculating a channel quality indicator CQI value according to received signal properties;
in addition, collecting the network high-level indicators includes:
performing normalization and weighted summation on basic indicators based on an adaptive weight mechanism to obtain a network stability index NSI, where the network stability index NSI is used for comprehensively evaluating stability of the network, with a calculation formula as follows:

$$NSI = w 1 \times RSSI\_norm + w 2 \times RTT\_norm + w 3 \times PacketLoss\_norm + w 4 \times Bandwidth\_norm + w 5 \times CQI\_norm ,$$

where weight coefficients w1-w5 are adjusted according to the actual situations, and xx_norm represents a normalized indicator value of the indicators;
calculating a ratio of a number of anomaly samples to a total number of samples through a size-configurable sliding window method to obtain an anomaly rate for evaluating anomaly situations of the network, with a calculation formula as follows:

$$AnomalyRate = ( number of anomaly samples / total number of samples ) ⨯ 100 \% ,$$

in the present embodiment, a window size of the sliding window is 5 minutes.

First, it is ensured that the collected data has a sufficient time span and a sufficient sample size so as to cover different network states, including a normal state and possible anomaly states, and then the collected data is pre-processed, including:
performing preliminary anomaly detection on data using a statistical method, for example, removing obvious noise and outliers in the data using a Z-score method, a box plot method and a standard deviation or IQR method to perform more precise anomaly detection, and filling in missing values through an interpolation method and a nearest neighbor interpolation method;
converting data features of different ranges and magnitudes to a same scale, and performing normalization and standardization on the data features to avoid imbalance of contribution of different features to the anomaly detection model due to differences in magnitude. In the present embodiment, a min-max normalization or Z-score standardization method is employed to scale the data to a range of [0, 1].

Then, performing construction of feature engineering on the pre-processed data includes:
selecting relevant features from the collected raw data based on random forest and a mutual information evaluation method, where the present embodiment uses correlation analysis, such as a Pearson correlation number, to evaluate the correlation between different features, and the use of highly-correlated features is avoided, so as not to generate redundant information. Features that are most valuable for anomaly detection are then screened by feature importance evaluation methods, such as feature importance in the random forest.

Time features including hour, minute, second and period features of time stamps in time series data are extracted to reflect time laws of the data; and feature combination is performed on the multi-dimensional data through an interactive feature generation method to capture non-linear relationships between different dimensions by calculating ratios or differences between features.

The multi-dimensional anomaly detection model includes a time series anomaly detection model, a multi-dimensional feature cluster analysis model and a rule engine detection model, as shown in FIG. 3.

Constructing the time series anomaly detection model includes:
collating the time series data into a format that fits input of the time series anomaly detection model, including a three-dimensional tensor of a number of samples, a time step and a number of features based on time series data features, and splitting the time series data into a training set, a validation set and a test set;
constructing a deep neural network model including multiple layers of long short-term memory LSTM structures, where the long short-term memory LSTM includes an input layer, one or more LSTM layers, a Dropout layer (preventing overfitting) and an output layer, constructing one simple LSTM model using Keras, and using the training set and a backpropagation algorithm for model training;
inputting the validation set to adjust hyperparameters, including a learning rate, a number of LSTM units and a Dropout proportion, based on grid search and cross validation methods;
performing predictive tests by inputting the test set, and using indicators including a recall rate, a precision rate and an F1 score for evaluating performance of the time series anomaly detection model.

Second, constructing the multi-dimensional feature cluster analysis model includes:
combining data in multiple dimensions into one feature matrix to create a sample data set such that each sample therein includes a plurality of features;
constructing the multi-dimensional feature cluster analysis model based on density-based spatial clustering of applications with noise DBSCAN, determining an optimal neighborhood radius and a minimum sample number parameter through the grid search, inputting the sample data into the multi-dimensional feature cluster analysis model, evaluating cluster quality using profile coefficients, and meanwhile, counting a proportion and plausibility of outlier points in combination with expert experience.

Again, constructing the rule engine detection model includes:
encoding various rules into executable logic based on the expert experience and historical anomaly cases, and building a rule base including rule priorities, trigger conditions and execution actions;
constructing the rule engine detection model through rule conflict detection and a priority ranking mechanism, and performing online evaluation and optimization of the rule engine detection model according to a number of anomalies triggered in actual applications, processing effects and resource consumption situations.

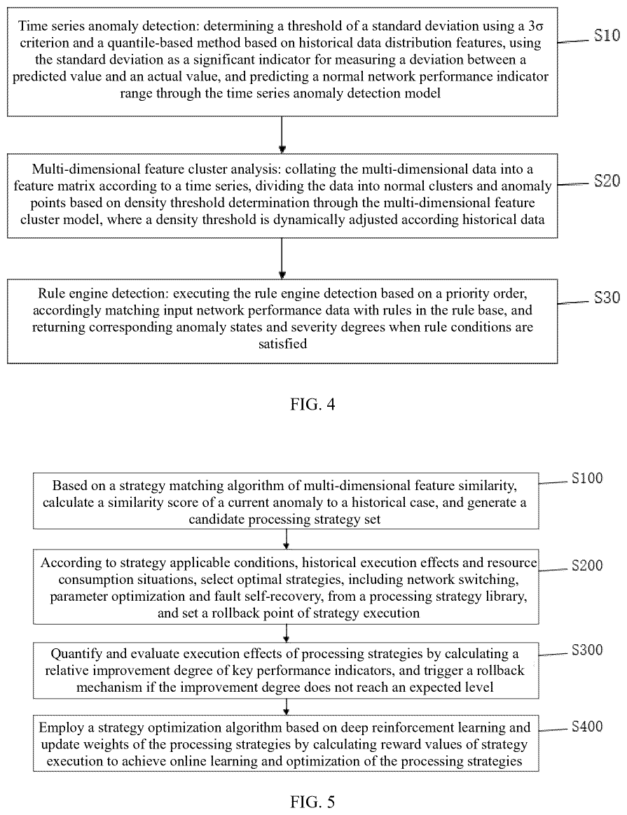

Then, time series anomaly detection based on a long short-term memory LSTM, multi-dimensional feature cluster analysis based on density-based spatial clustering of applications with noise DBSCAN and rule engine detection based on expert rules are performed through the multi-dimensional anomaly detection model, as shown in FIG. 4, specifically including:
S10: determining a threshold of a standard deviation using a 36 criterion and a quantile-based method based on historical data distribution features, when time series anomaly detection is performed by the trained time series anomaly detection model, using the standard deviation as a significant indicator for measuring a deviation between a predicted value and an actual value, and predicting a normal network performance indicator range; in the present embodiment, anomaly determination conditions are as follows:

$$if \vert actual value - predicted value \text{\textbar >} 3 ⨯ σ ( standard deviation ) , anomalies are determined ,$$

for the RTT indicator, if the predicted value is 50 ms and the standard deviation is 10 ms, anomalies are determined when the actual value exceeds 80 ms;
S20: taking data in multiple dimensions as features, collating data of different time points into one multi-dimensional data matrix, where each sample point includes feature values of multiple dimensions, dividing regions with sufficiently high density into clusters by the multi-dimensional feature cluster model, and considering points in low-density regions as noise or outlier points, where in the present embodiment, core parameters: ε=0.5, MinPts=4, one DBSCAN object is created, where & is a neighborhood radius, MinPts is a minimum number of samples, the feature matrix X is input into the model for clustering, and the cluster to which each sample belongs is predicted, and −1 represents an outlier point, i.e., an outlier point;
S30: executing the rule engine detection based on a priority order, accordingly matching input network performance data with rules in the rule base, that is, determining the input network performance data by different rules, returning to the corresponding anomaly states if a certain rule condition is satisfied, otherwise, returning to normal; in the present embodiment, the rule base is shown as follows:

$$rule 1 : if RTT > 200 ms and the duration > 30 s , anomalies are determined ;$$

$$rule 2 : if PacketLoss > 5 \% and the duration > 15 s , anomalies are determined ;$$

$$rule 3 : if the bandwidth availability < 20 \% and the signal strength is normal , anomalies are determined ;$$

In step S2, the classifying the detected anomalies further includes:
determining classes to which anomaly items belong based on the hierarchical classification strategy, where the classes of the anomalies include:
anomalies in a network congestion class, eigenvectors of the anomalies being manifested as high network delay, a high packet loss rate and a low bandwidth availability;
anomalies in a signal interference class, eigenvectors of the anomalies being manifested as low signal strength, a low channel quality indicator and a high bit error rate; and
anomalies in a hardware fault class, eigenvectors of the anomalies being manifested as bursty disconnection, abnormal restart and configuration errors;
meanwhile, setting a severity degree level for each class of anomalies, and performing priority ranking based on a duration, an impact range and a service impact degree of the anomalies. The expression is as follows:

A. Anomalies in a network congestion class:

$$Eigenvector = [ high RTT , high packet loss rate , low bandwidth availability ] ;$$

B. Anomalies in a signal interference class:

$$Eigenvector = [ low RSSI , low CQI , high bit error rate ] ;$$

C. Anomalies in a hardware fault class:

$$Eigenvector = [ bursty disconnection , abnormal restart , configuration error ] .$$

The anomalies output through detection with the multi-dimensional anomaly detection model are then automatically processed, as shown in FIG. 5, including:
S100: based on a strategy matching algorithm of multi-dimensional feature similarity, calculating a similarity score of a current anomaly to a historical case according to similarity of a current anomaly detection result with a historical case in multiple dimensions, and generating processing strategies, in the present embodiment, an algorithm formula is as follows:

$$Score ( strategy i ) = \sum ( wj ⨯ similarity j ) ,$$

where wj are weights of various dimensions, and similarity j is similarity of a current anomaly to the historical cases;
S200: according to the processing strategy obtained by calculation, strategy applicable conditions, historical execution effects and resource consumption situations, selecting optimal strategies, including network switching, parameter optimization and fault self-recovery, from a processing strategy library, and setting a rollback point of strategy execution, where in the present embodiment, the processing strategy library is as follows:

### Strategy 1: Network Switching

Applicable conditions: current network quality score<60 and backup network is available

### Execution Steps:

a) scanning for available network,
b) evaluating backup network quality,
c) executing smooth switching;

### Strategy 2: Parameter Optimization

Applicable conditions: 60≤network quality score<80

### Execution Steps:

a) adjusting transmit power,
b) optimizing channel configuration,
c) updating QoS strategies;

### Strategy 3: Fault Self-Recovery

Applicable conditions: hardware-level anomalies are detected

### Execution Steps:

a) attempting to reset the network interface,
b) restoring default configuration,
c) starting a standby module;
S300: quantifying and evaluating execution effects of processing strategies by calculating a relative improvement degree of key performance indicators, i.e. calculating a relative change of the network performance indicator value after execution of the processing strategies and the initial value before processing, and triggering a rollback mechanism if the improvement degree does not reach an expected level, with a calculation formula as follows:

$$EffectScore = ( indicator value after processing - indicator value before processing ) / indicator value before processing ⨯ 100 \% ;$$

S400: adopting a strategy optimization algorithm based on deep reinforcement learning, and updating weights of the processing strategies by calculating deviations of execution effects and expected effects of actual processing strategies in combination with the feature values to optimize subsequent strategy selection, with a strategy optimization formula as follows:

$$w ' i = w i + α ⨯ ( actual effect - expected effect ) ⨯ i ,$$

where α is a learning rate, the value is taken as 0.1, and i is an eigenvalue.

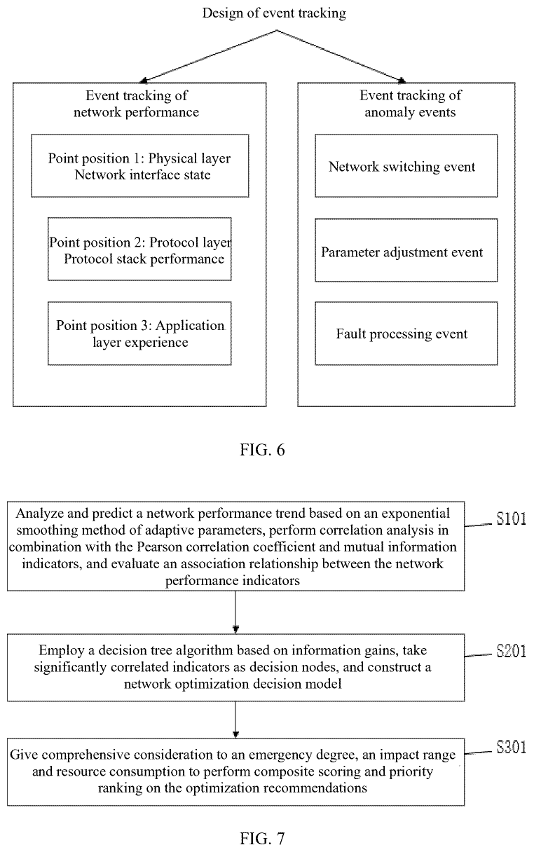

Further, in step S4, the performing multi-level event tracking on network performance indicators and anomaly events is as shown in FIG. 6, specifically including:

setting a sampling frequency of event tracking based on importance of the hierarchical sampling strategy, employing high-frequency sampling for the core indicators, employing low-frequency sampling for the secondary indicators, with a range from 1 s-5 min, acquiring a network interface state (point 1), protocol stack performance (point 2) and application layer experience (point 3) in real time, monitoring physical connection states of the network interface, a working rate and a duplex mode, evaluating performance of different protocol layers, and evaluating performance of an application program from the user perspective;
collecting and storing data at various layers, including a physical layer, a protocol layer and an application layer, of the network in real time, where
data at the physical layer includes: network interface states, physical connection states, an operating rate and a duplex mode;
data at the protocol layer includes: TCP/IP performance indicators, protocol stack states and network protocol interaction data;
data at the application layer includes: service response time, a service success rate and user experience data;
recording anomaly events and their complete lifecycles in real time, where the anomaly events include network switching events, parameter adjustment events and fault processing events, and recorded content includes event occurrence time, type determination, processing processes, execution results and effect evaluation.

Next, as shown in FIG. 7, generating the optimization recommendations further includes:

S101: analyzing and predicting a network performance trend based on an exponential smoothing method of adaptive parameters, with a formula as follows:
St=α×Yt+(1−α)×St−1, where α is a smoothing coefficient, the value is taken as 0.3, Yt is an actual observation at time t, and St is a smoothed value at time t;
then, performing correlation analysis in combination with the Pearson correlation coefficient and mutual information indicators, and evaluating an association relationship between the network performance indicators, with a formula as follows:

$$r = Σ ( ( X i - \overline{X} ) ( Y i - \overline{Y} ) ) / √ ( {Σ ( X i - \overline{X} )}^{2} \times {Σ ( Y i - \overline{Y} )}^{2} ) ,$$

where X and Y are mean values of two variables X and Y, and the Pearson correlation coefficient r measures linear correlation between the two variables X and Y, with a range from −1 to 1, to evaluate the relationship between network performance indicators, where r=1 represents perfect positive correlation, r=−1 represents perfect negative correlation, and r=0 represents no-linear correlation;
S201: using a CART algorithm based on information gains for constructing a decision tree, taking significantly correlated indicators as decision nodes, and constructing a network optimization decision model;
S301: performing composite scoring and priority ranking on the optimization recommendations according to the following factors:
an emergency degree based on the severity degrees and the impact ranges of the anomalies;
resource consumption based on required resources and technical conditions;
an impact range based on historical optimization effects and service impact evaluation;
meanwhile, building an execution feedback mechanism of the optimization recommendations, and continuously evaluating and improving the optimization effects. The formula is as follows:

$$Priority = Urgency ⨯ Impact ⨯ Resource ,$$

where Urgency: emergency degree (1-5 points), Impact: impact range (1-5 points), Resource: resource consumption (1-5 points).

In summary, the method of the present embodiment provides a complete network anomaly detection and automatic processing solution through systematic design and implementation. Network service quality and user experience are efficiently enhanced by combining technologies such as machine learning, expert systems and automatic control. The technical bottleneck of conventional network monitoring passive response is broken through, and a closed-loop intelligent network management system is constructed. First, at the level of indicator collection, the solution designs a multi-dimensional data collection system based on a netguard framework and introduces a sliding window mechanism for dynamic evaluation. Second, at the level of anomaly identification, the accuracy and reliability of anomaly detection are significantly improved by fusing multiple machine learning algorithms. Again, at the level of automatic processing, continuous optimization and self-evolution of the system are achieved by building a complete data event tracking and analysis system.

The present embodiment further provides a network anomaly detection and automatic processing system, including:
an indicator collection module for collecting multi-dimensional data related to network performance, performing pre-processing including noise removal, outlier processing and data standardization on collected data, and performing construction of feature engineering on pre-processed data;
an anomaly detection module for constructing a multi-dimensional anomaly detection model based on deep learning and machine learning algorithms, and performing time series anomaly detection based on a long short-term memory LSTM, multi-dimensional feature cluster analysis based on density-based spatial clustering of applications with noise DBSCAN and rule engine detection based on expert rules through the multi-dimensional anomaly detection model;
a strategy execution model for performing classification on anomalies output through detection with the multi-dimensional anomaly detection model based on a hierarchical classification strategy, and executing corresponding automatic processing strategies according to anomaly types;
a data analysis module for performing multi-level event tracking on network performance indicators and anomaly events, monitoring states of various layers of a network in real time and tracking and recording the anomaly events, meanwhile, performing trend prediction analysis on network performance data through an exponential smoothing method, performing correlation analysis based on a Pearson correlation coefficient to mine data values, and generating optimization recommendations on the basis of prediction analysis results in combination with a decision tree algorithm.

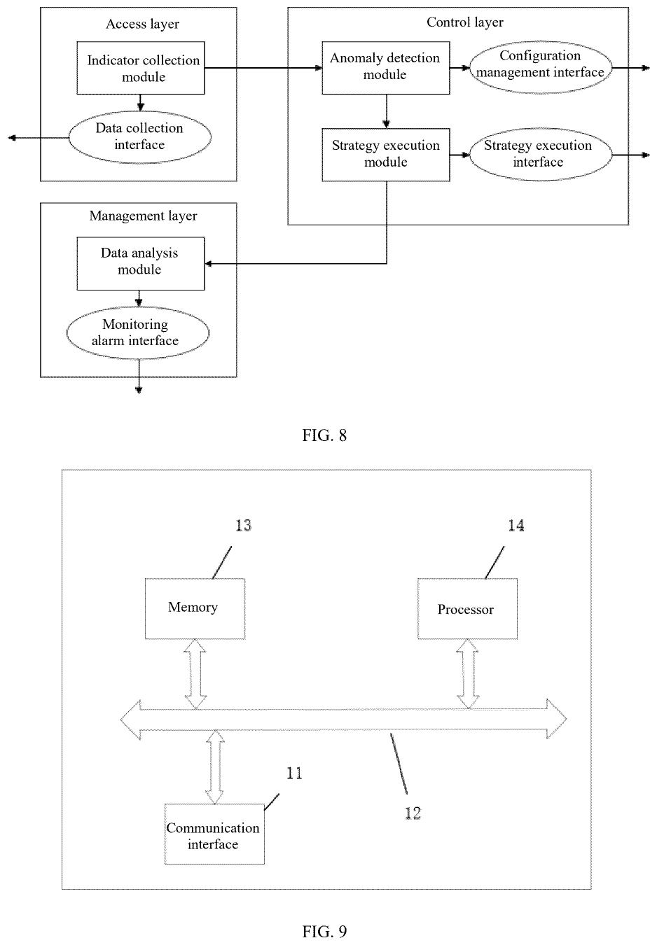

The integration and deployment structures of the network anomaly detection and automatic processing system are as shown in FIG. 8; the resource occupation is optimized for achieving performance optimization, including memory pool management, thread pool optimization and queue management; meanwhile, the processing delay, including asynchronous processing, batch processing and priority scheduling, is optimized.

The functional implementation of various modules and units correspond to those of various steps in the above-described embodiments of the network anomaly detection and automatic processing method, and the functions and implementation processes thereof will not be described in detail herein.

The present embodiment further provides an electronic device, as shown in FIG. 9, the electronic device includes a processor 14 and a memory 13, the memory 13 has stored thereon machine executable instructions executable by the processor 14, and the processor 14 executes the machine executable instructions to implement the above-described network anomaly detection and automatic processing method.

Further, the electronic device shown in FIG. 9 further includes a bus 12 and a communication interface 11, and the processor 14, the communication interface 11 and the memory 13 are connected through the bus 12.

The memory 13 may include a high-speed random access memory (RAM) or may further include a non-volatile memory, for example, at least one magnetic disk memory. Communication connection between a network element of the system and at least one other network element is achieved through at least one communication interface 11 (which may be wired or wireless), and the Internet, a wide area network, a local area network, a metropolitan area network, or the like may be used. The bus 12 may be an ISA bus, a PCI bus, or an EISA bus, among others. The bus may be divided into an address bus, a data bus, a control bus, and the like. For ease of representation, only one bi-directional arrow is shown in FIG. 9, but it does not indicate that there is only one bus or one type of bus.

The processor 14 may be an integrated circuit chip having a signal processing capability. In the implementation processes, various steps of the above-described method may be completed by instructions in the form of software or integrated logic of hardware in the processor 14. The above-described processor 14 may be a general-purpose processor, including a central processing unit (CPU), a network processor (NP), or the like; it may also be a digital signal processor (DSP), an application specific integrated circuit (ASIC), a field-programmable gate array (FPGA) or other programmable logic devices, discrete gates or transistor logic devices, and discrete hardware assemblies. Various methods, steps, and logic block diagrams disclosed in the present embodiment may be implemented or performed. The general-purpose processor may be a microprocessor or the processor may be any conventional processor or the like. The steps of the methods disclosed in connection with the present embodiments may be manifested directly as being executed and completed by a hardware decoding processor, or as being executed and completed by a combination of hardware and software modules in a decoding processor. The software module may be located in a random access memory, a flash memory, a read-only memory, a programmable read-only memory, or electrically erasable and programmable memory, a register, and like storage media well known in this field. The storage medium is located in the memory 1001, and the processor 1000 reads information in the memory 1001 and performs the steps of the network anomaly detection and automatic processing method in conjunction with its hardware.

The present disclosure further provides a computer-readable storage medium, the computer-readable storage medium may be a non-volatile computer-readable storage medium, the computer-readable storage medium may also be a volatile computer-readable storage medium, and the computer-readable storage medium has stored therein a computer program which, when run on a computer, causes the computer to perform the steps of the network anomaly detection and automatic processing method.

Finally, it should be noted that the above are only preferred implementations of the present disclosure, the scope of protection of the present disclosure is not limited to the above embodiments, and the technical solutions falling under the idea of the present disclosure fall within the scope of protection of the present disclosure. It should be noted that for those of ordinary skill in the art, several modifications and adaptations can be made without departing from the principles of the present disclosure, and these modifications and adaptations should also be regarded as the scope of protection of the present disclosure.

Various technical features of the above-described embodiments may be combined at random, and in order to make the description concise, not all possible combinations of the technical features of the above-described embodiments are described. However, as long as there is no contradiction in the combination of the technical features, they should all be regarded as falling within the scope described in the present specification.

Finally, it should be noted that the above are only preferred implementations of the present disclosure, the scope of protection of the present disclosure is not limited to the above embodiments, and the technical solutions falling under the idea of the present disclosure fall within the scope of protection of the present disclosure. It should be noted that for those of ordinary skill in the art, several modifications and adaptations can be made without departing from the principles of the present disclosure, and these modifications and adaptations should also be regarded as the scope of protection of the present disclosure.

Various technical features of the above-described embodiments may be combined at random, and in order to make the description concise, not all possible combinations of the technical features of the above-described embodiments are described. However, as long as there is no contradiction in the combination of the technical features, they should all be regarded as falling within the scope described in the present specification.

What is claimed is:

1. A network anomaly detection and automatic processing method, comprising the following steps:
S1: collecting multi-dimensional data related to network performance, performing pre-processing comprising noise removal, outlier processing, and data standardization on collected data, and performing construction of feature engineering on pre-processed data;
S2: constructing a multi-dimensional anomaly detection model based on deep learning and machine learning algorithms, and performing time series anomaly detection based on a long short-term memory LSTM, multi-dimensional feature cluster analysis based on density-based spatial clustering of applications with noise DBSCAN, and rule engine detection based on expert rules through the multi-dimensional anomaly detection model;
S3: performing classification on anomalies output through detection with the multi-dimensional anomaly detection model based on a hierarchical classification strategy, and executing corresponding automatic processing strategies according to anomaly types; and
S4: performing multi-level event tracking on network performance indicators and anomaly events, setting a sampling frequency of event tracking based on a hierarchical sampling strategy, employing high-frequency sampling for core indicators, employing low-frequency sampling for secondary indicators, monitoring states of various layers of network in real time and tracking and recording the anomaly events, meanwhile, performing trend prediction analysis on network performance data through an exponential smoothing method, performing correlation analysis based on a Pearson correlation coefficient to mine data values, and generating optimization recommendations on the basis of prediction analysis results in combination with a decision tree algorithm;
in step S3, the executing the corresponding automatic processing strategies according to the anomaly types comprises:
based on a strategy matching algorithm of multi-dimensional feature similarity, calculating a similarity score of a current anomaly to a historical case, and generating a candidate processing strategy set;
according to strategy applicable conditions, historical execution effects, and resource consumption situations, selecting optimal strategies, comprising network switching, parameter optimization, and fault self-recovery, from a processing strategy library, and setting a rollback point of strategy execution;
quantifying and evaluating execution effects of processing strategies by calculating a relative improvement degree of key performance indicators, and triggering a rollback mechanism if the improvement degree does not reach an expected level; and
employing a strategy optimization algorithm based on deep reinforcement learning and updating weights of the processing strategies by calculating reward values of strategy execution to achieve online learning and optimization of the processing strategies.

2. The network anomaly detection and automatic processing method according to claim 1, wherein in step S1, the multi-dimensional data comprises network basic indicators and network high-level indicators;
wherein collecting the network basic indicators comprises:
collecting signal strength RSSI of a network continuously according to a configurable time interval, and evaluating a degree of weakness of wireless signals in transmission;
acquiring round-trip time RTT by recording a time difference between sending a specific detection request packet to a target server and receiving a response packet returned by the target server in an active detection manner;
recording, at a sending end, a total number of data packets sent within a specific time period based on a sliding window mechanism, and acquiring a data packet loss rate;
acquiring traffic statistical information of network interfaces by a management interface provided by a network device to acquire a bandwidth availability; and
calculating a channel quality indicator CQI value in real time according to received signal properties;
wherein collecting the network high-level indicators comprises:
performing normalization and weighted summation on basic indicators based on an adaptive weight mechanism to obtain a network stability index NSI, wherein the network stability index NSI is used for comprehensively evaluating stability of the network, wherein a weight coefficient is adjusted according to actual situations; and
calculating a ratio of a number of anomaly samples to a total number of samples through a size-configurable sliding window method to obtain an anomaly rate for evaluating anomaly situations of the network.

3. The network anomaly detection and automatic processing method according to claim 1, wherein in step S1, the performing pre-processing comprising noise removal, outlier processing, and data standardization on the collected data further comprises:
performing preliminary anomaly detection on data using a statistical method, comprising removing obvious noise and outliers in the data using a Z-score method and a box plot method, and filling in missing values through an interpolation method and a nearest neighbor interpolation method; and
employing a Z-score standardization method to convert data features of different ranges and magnitudes to a same scale, and performing normalization and standardization on the data features to avoid imbalance of contribution of different features to the anomaly detection model due to differences in magnitude.

4. The network anomaly detection and automatic processing method according to claim 1, wherein in step S1, the performing construction of feature engineering on the pre-processed data further comprises:
selecting relevant features from collected raw data based on random forest and mutual information evaluation methods, and screening features most valuable for anomaly detection through a feature importance evaluation method; and
extracting time features comprising hour, minute, second, and period features of time stamps in time series data, and performing feature combination on the multi-dimensional data through an interactive feature generation method to capture non-linear relationships between different dimensions.

5. The network anomaly detection and automatic processing method according to claim 4, wherein in step S2, the multi-dimensional anomaly detection model comprises a time series anomaly detection model, a multi-dimensional feature cluster analysis model, and a rule engine detection model, wherein constructing the time series anomaly detection model comprises:
collating the time series data into a three-dimensional tensor format comprising a number of samples, a time step, and a number of features based on time series data features, and splitting the time series data into a training set, a validation set, and a test set according to a set proportion;
constructing a deep neural network model comprising multiple layers of long short-term memory LSTM structures, and using the training set and a backpropagation algorithm for model training;
inputting the validation set to adjust hyperparameters, comprising a learning rate, a number of LSTM units, and a Dropout proportion, based on grid search and cross validation methods; and
performing predictive tests by inputting the test set, and using indicators comprising a recall rate, a precision rate, and an F1 score for evaluating performance of the time series anomaly detection model.

6. The network anomaly detection and automatic processing method according to claim 5, wherein constructing the multi-dimensional feature cluster analysis model comprises:
creating a sample data set comprising multi-dimensional features by merging data in multiple dimensions into one feature matrix based on feature correlation analysis; and
constructing the multi-dimensional feature cluster analysis model based on density-based spatial clustering of applications with noise DBSCAN, determining an optimal neighborhood radius and a minimum sample number parameter through the grid search, evaluating cluster quality using a profile coefficient and a DTW distance, and meanwhile, evaluating plausibility of outlier points in combination with expert experience.

7. The network anomaly detection and automatic processing method according to claim 5, wherein constructing the rule engine detection model comprises:
encoding various rules into executable logic based on expert experience and historical anomaly cases, and building a rule base comprising rule priorities, trigger conditions, and execution actions; and
constructing the rule engine detection model through rule conflict detection and a priority ranking mechanism, and performing online evaluation and optimization of the rule engine detection model according to a number of anomalies triggered in actual applications, processing effects and resource consumption situations.

8. The network anomaly detection and automatic processing method according to claim 5, wherein in step S2, the performing time series anomaly detection based on the long short-term memory LSTM, multi-dimensional feature cluster analysis based on the density-based spatial clustering of applications with noise DBSCAN, and rule engine detection based on the expert rules through the multi-dimensional anomaly detection model further comprises:
determining a threshold of a standard deviation using a 3σ criterion and a quantile-based method based on historical data distribution features, using the standard deviation as a significant indicator for measuring a deviation between a predicted value and an actual value, and predicting a normal network performance indicator range through the time series anomaly detection model;
collating the multi-dimensional data into a feature matrix according to a time series, dividing the data into normal clusters and anomaly points based on density threshold determination through the multi-dimensional feature cluster model, wherein a density threshold is dynamically adjusted according historical data; and
executing the rule engine detection based on a priority order, accordingly matching input network performance data with rules in a rule base, and returning corresponding anomaly states and severity degrees when rule conditions are satisfied.

9. The network anomaly detection and automatic processing method according to claim 1, wherein in step S2, the performing classification on the anomalies output through detection with the multi-dimensional anomaly detection model based on the hierarchical classification strategy further comprises:
determining classes to which anomaly items belong based on the hierarchical classification strategy, wherein the classes of the anomalies comprise:
anomalies in a network congestion class, eigenvectors of the anomalies being manifested as high network delay, a high packet loss rate, and a low bandwidth availability;
anomalies in a signal interference class, eigenvectors of the anomalies being manifested as low signal strength, a low channel quality indicator, and a high bit error rate; and
anomalies in a hardware fault class, eigenvectors of the anomalies being manifested as bursty disconnection, abnormal restart, and configuration errors; and
meanwhile, setting a severity degree level for each class of anomalies, and performing priority ranking based on a duration, an impact range, and a service impact degree of the anomalies.

10. The network anomaly detection and automatic processing method according to claim 1, wherein in step S4, the performing multi-level event tracking on the network performance indicators and the anomaly events further comprises:
collecting and storing data at various layers, comprising a physical layer, a protocol layer and an application layer, of the network in real time, wherein
data at the physical layer comprises: network interface states, physical connection states, an operating rate, and a duplex mode;
data at the protocol layer comprises: TCP/IP performance indicators, protocol stack states, and network protocol interaction data; and
data at the application layer comprises: service response time, a service success rate, and user experience data; and
recording anomaly events and their complete lifecycles in real time, wherein the anomaly events comprise network switching events, parameter adjustment events, and fault processing events, and recorded content comprises event occurrence time, type determination, processing processes, execution results, and effect evaluation.

11. The network anomaly detection and automatic processing method according to claim 1, wherein in step S4, the generating the optimization recommendations further comprises:
analyzing and predicting a network performance trend based on an exponential smoothing method of adaptive parameters, performing correlation analysis in combination with the Pearson correlation coefficient and mutual information indicators, and evaluating an association relationship between the network performance indicators;
employing a decision tree algorithm based on information gains, taking significantly correlated indicators as decision nodes, and constructing a network optimization decision model;
performing composite scoring and priority ranking on the optimization recommendations according to the following factors:
an emergency degree based on severity degrees and impact ranges of the anomalies;
resource consumption based on required resources and technical conditions; and
an impact range based on historical optimization effects and service impact evaluation; and
meanwhile, building an execution feedback mechanism of the optimization recommendations, and continuously evaluating and improving the optimization effects.

12. A network anomaly detection and automatic processing system, comprising:
an indicator collection module for collecting multi-dimensional data related to network performance, performing pre-processing comprising noise removal, outlier processing, and data standardization on collected data, and performing construction of feature engineering on pre-processed data;
an anomaly detection module for constructing a multi-dimensional anomaly detection model based on deep learning and machine learning algorithms, and performing time series anomaly detection based on a long short-term memory LSTM, multi-dimensional feature cluster analysis based on density-based spatial clustering of applications with noise DBSCAN, and rule engine detection based on expert rules through the multi-dimensional anomaly detection model;
a strategy execution model for performing classification on anomalies output through detection with the multi-dimensional anomaly detection model based on a hierarchical classification strategy, and executing corresponding automatic processing strategies according to anomaly types; and
a data analysis module for performing multi-level event tracking on network performance indicators and anomaly events, setting a sampling frequency of event tracking based on a hierarchical sampling strategy, employing high-frequency sampling for core indicators, employing low-frequency sampling for secondary indicators, monitoring states of various layers of a network in real time and tracking and recording the anomaly events, meanwhile, performing trend prediction analysis on network performance data through an exponential smoothing method, performing correlation analysis based on a Pearson correlation coefficient to mine data values, and generating optimization recommendations on the basis of prediction analysis results in combination with a decision tree algorithm;
wherein the executing the corresponding automatic processing strategies according to the anomaly types comprises:
based on a strategy matching algorithm of multi-dimensional feature similarity, calculating a similarity score of a current anomaly to a historical case, and generating a candidate processing strategy set;
according to strategy applicable conditions, historical execution effects, and resource consumption situations, selecting optimal strategies, comprising network switching, parameter optimization, and fault self-recovery, from a processing strategy library, and setting a rollback point of strategy execution;
quantifying and evaluating execution effects of processing strategies by calculating a relative improvement degree of key performance indicators, and triggering a rollback mechanism if the improvement degree does not reach an expected level; and
employing a strategy optimization algorithm based on deep reinforcement learning and updating weights of the processing strategies by calculating reward values of strategy execution to achieve online learning and optimization of the processing strategies.

13. A computer-readable storage medium having a computer program stored thereon, wherein the program, when executed by a processor, implements the network anomaly detection and automatic processing method according to claim 1.

14. An electronic device, comprising:
one or more processors, and
a storage device for storing one or more programs;
wherein the one or more programs, when executed by the one or more processors, cause the one or more processors to implement the network anomaly detection and automatic processing method according to claim 1.

15. The network anomaly detection and automatic processing method according to claim 6, wherein in step S2, the performing time series anomaly detection based on the long short-term memory LSTM, multi-dimensional feature cluster analysis based on the density-based spatial clustering of applications with noise DBSCAN, and rule engine detection based on the expert rules through the multi-dimensional anomaly detection model further comprises:
determining a threshold of a standard deviation using a 30 criterion and a quantile-based method based on historical data distribution features, using the standard deviation as a significant indicator for measuring a deviation between a predicted value and an actual value, and predicting a normal network performance indicator range through the time series anomaly detection model;
collating the multi-dimensional data into a feature matrix according to a time series, dividing the data into normal clusters and anomaly points based on density threshold determination through the multi-dimensional feature cluster model, wherein a density threshold is dynamically adjusted according historical data; and
executing the rule engine detection based on a priority order, accordingly matching input network performance data with rules in a rule base, and returning corresponding anomaly states and severity degrees when rule conditions are satisfied.

16. The network anomaly detection and automatic processing method according to claim 7, wherein in step S2, the performing time series anomaly detection based on the long short-term memory LSTM, multi-dimensional feature cluster analysis based on the density-based spatial clustering of applications with noise DBSCAN, and rule engine detection based on the expert rules through the multi-dimensional anomaly detection model further comprises:
determining a threshold of a standard deviation using a 3σ criterion and a quantile-based method based on historical data distribution features, using the standard deviation as a significant indicator for measuring a deviation between a predicted value and an actual value, and predicting a normal network performance indicator range through the time series anomaly detection model;
collating the multi-dimensional data into a feature matrix according to a time series, dividing the data into normal clusters and anomaly points based on density threshold determination through the multi-dimensional feature cluster model, wherein a density threshold is dynamically adjusted according historical data; and
executing the rule engine detection based on a priority order, accordingly matching input network performance data with rules in the rule base, and returning corresponding anomaly states and severity degrees when rule conditions are satisfied.

17. The computer-readable storage medium according to claim 13, wherein in step S1 of the network anomaly detection and automatic processing method, the multi-dimensional data comprises network basic indicators and network high-level indicators;
wherein collecting the network basic indicators comprises:
collecting signal strength RSSI of a network continuously according to a configurable time interval, and evaluating a degree of weakness of wireless signals in transmission;
acquiring round-trip time RTT by recording a time difference between sending a specific detection request packet to a target server and receiving a response packet returned by the target server in an active detection manner;
recording, at a sending end, a total number of data packets sent within a specific time period based on a sliding window mechanism, and acquiring a data packet loss rate;
acquiring traffic statistical information of network interfaces by a management interface provided by a network device to acquire a bandwidth availability; and
calculating a channel quality indicator CQI value in real time according to received signal properties;
wherein collecting the network high-level indicators comprises:
performing normalization and weighted summation on basic indicators based on an adaptive weight mechanism to obtain a network stability index NSI, wherein the network stability index NSI is used for comprehensively evaluating stability of the network, wherein a weight coefficient is adjusted according to actual situations; and
calculating a ratio of a number of anomaly samples to a total number of samples through a size-configurable sliding window method to obtain an anomaly rate for evaluating anomaly situations of the network.

18. The computer-readable storage medium according to claim 13, wherein in step S1 of the network anomaly detection and automatic processing method, the performing pre-processing comprising noise removal, outlier processing, and data standardization on the collected data further comprises:
performing preliminary anomaly detection on data using a statistical method, comprising removing obvious noise and outliers in the data using a Z-score method and a box plot method, and filling in missing values through an interpolation method and a nearest neighbor interpolation method; and
employing a Z-score standardization method to convert data features of different ranges and magnitudes to a same scale, and performing normalization and standardization on the data features to avoid imbalance of contribution of different features to the anomaly detection model due to differences in magnitude.

19. The computer-readable storage medium according to claim 13, wherein in step S1 of the network anomaly detection and automatic processing method, the performing construction of feature engineering on the pre-processed data further comprises:
selecting relevant features from collected raw data based on random forest and mutual information evaluation methods, and screening features most valuable for anomaly detection through a feature importance evaluation method; and
extracting time features comprising hour, minute, second, and period features of time stamps in time series data, and performing feature combination on the multi-dimensional data through an interactive feature generation method to capture non-linear relationships between different dimensions.

20. The computer-readable storage medium according to claim 19, wherein in step S2 of the network anomaly detection and automatic processing method, the multi-dimensional anomaly detection model comprises a time series anomaly detection model, a multi-dimensional feature cluster analysis model, and a rule engine detection model, wherein constructing the time series anomaly detection model comprises:
collating the time series data into a three-dimensional tensor format comprising a number of samples, a time step, and a number of features based on time series data features, and splitting the time series data into a training set, a validation set, and a test set according to a set proportion;
constructing a deep neural network model comprising multiple layers of long short-term memory LSTM structures, and using the training set and a backpropagation algorithm for model training;
inputting the validation set to adjust hyperparameters, comprising a learning rate, a number of LSTM units, and a Dropout proportion, based on grid search and cross validation methods; and
performing predictive tests by inputting the test set, and using indicators comprising a recall rate, a precision rate, and an F1 score for evaluating performance of the time series anomaly detection model.
